(19) United States
(12) Patent Application Publication
(10) Pub. No.: US 2004/0069807 A1
(43) Pub. Date: Apr. 15, 2004

(54) Foam forming unit

(76) Inventors: Markus Franciskus Brouwer, MS Heesch (NL); Johannes Hubertus Jozef Maria Kelders, RL Drunen (NL)

Correspondence Address: Richard L Byrne, 700 Koppers Building, 436 Seventh Avenue, Pittsburgh, PA, 15219-1818, US

(21) Appl. No.: 10/432,479

(22) PCT Filed: Nov. 23, 2001
(86) PCT No.: PCT/NL01/00852

(30) Foreign Application Priority Data
Nov. 23, 2000 (NL) 101 6694

(51) Int. Cl. B67D 5/64

(52) U.S. Cl. 222/175; 222/153.1

(57) ABSTRACT

A foam forming unit particularly suitable for a liquid container, comprising a pump for liquid and a pump for air, which are each provided with an inlet and an outlet, said foam forming unit further comprising a mixing chamber which is in communication with the outlet of each pump, a dispensing part provided with an outflow channel with a foam opening, the channel being in communication with the mixing chamber, and valves in respectively the inlet and the outlet of each pump for drawing in respectively delivering air and liquid, wherein one or more valves are formed integrally with the air pump or liquid pump into a single construction element.

The invention relates to a foam forming unit particularly suitable for a liquid container, comprising a pump for air and a pump for liquid, which are each provided with an inlet and an outlet, said foam forming unit further comprising a mixing chamber which is in communication with the outlet of each pump, a dispensing part provided with an outflow channel with a foam opening, the channel being in communication with the mixing chamber, and valves in respectively the inlet and the outlet of each pump for drawing in respectively delivering air and liquid.

Such a foam forming unit is known from the international patent application WO 97/13585. Although this foam forming unit can generate a good foam, i.e. a foam of correct texture, this known foam forming unit consists of a large number of construction components manufactured from different materials. The cost of manufacturing such a foam forming unit is therefore relatively high.

The object of the present invention is to improve the foam forming unit known from the prior art.

For this purpose the foam forming unit is characterized according to the invention in that one or more valves are formed integrally with the air pump or liquid pump into a single construction element. By combining functions the number of construction components can in this way be reduced, which results in lower manufacturing costs.

In one embodiment each pump comprises a pressure chamber with a piston displaceable relative to the pressure chamber. Pressure is built up in the chamber of the pump by displacing the piston.

In further preference the outlet valve of the liquid pump is formed integrally with the piston of the liquid pump, thereby further reducing the number of construction components.

The foam forming unit according to the invention further comprises an operating member for operating the two pumps, which can be situated concentrically, eccentrically as well as adjacently of each other.

In order to reduce the number of construction components still further, the operating member is formed integrally with the piston of the air pump. Displacement of the operating member results directly in a displacement of the piston of the air pump relative to the chamber thereof.

In a further embodiment a coupling element is arranged between the operating member and the piston of the liquid pump, wherein the coupling element transmits the displacement of the operating member to the piston. In preference the coupling element is herein formed integrally with the outlet valve and/or the inlet valve of the air pump, which once again results in fewer construction components.

Use is advantageously made of injection moulded elements of plastic to obtain the single construction elements.

In such a case a valve is formed by a membrane of a predetermined thickness formed on the injection moulded element. The valve characteristic can be determined by choosing the thickness of the membrane and the type of material.

A final proposal according to the invention for the purpose of reducing the number of construction components is one wherein the inlet valve of the liquid pump is formed by a stopper body which co-acts with a sealing rib arranged in the piston of the relevant pump. In addition to this stopper body serving as inlet valve to the liquid pressure chamber, a so-called liquid lock is hereby also created. A liquid lock serves to close the passage to the outside for liquid when the pressure in the liquid container, on which the foam forming unit is placed, increases because it is for instance squeezed or the ambient pressure increases.

The invention finally also relates to a foam dispensing assembly consisting of a liquid container and a foam forming unit, wherein this unit is formed by a foam forming unit according to the invention.

The invention will now be further elucidated with reference to the annexed drawing. In the drawing:

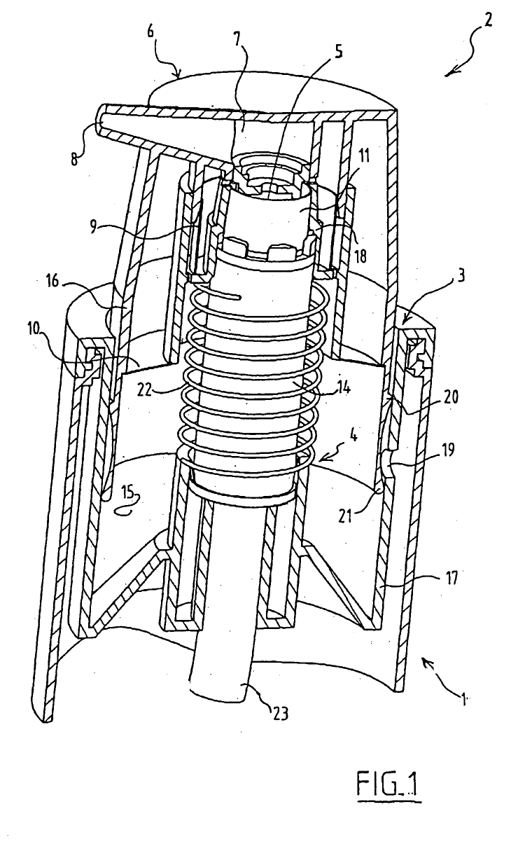

FIG. 1 shows a perspective, cross-sectional view of a foam dispensing assembly according to the invention,

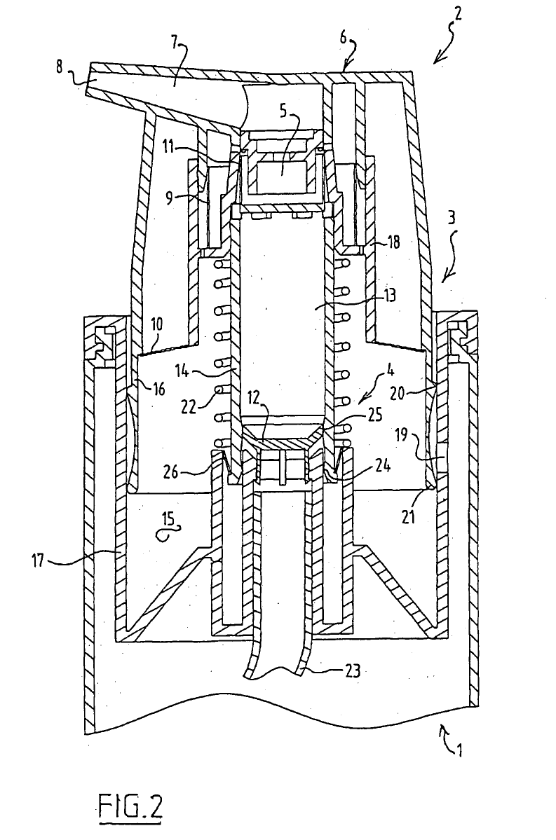

FIG. 2 shows a cross-section of the foam dispensing assembly of FIG. 1 in a first extreme position,

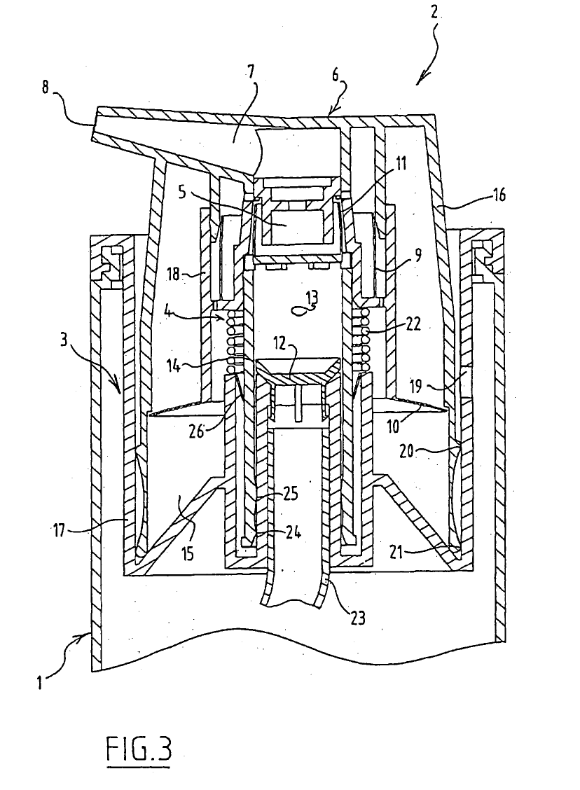

FIG. 3 shows a cross-section of the foam dispensing assembly of FIG. 1 in a second extreme position, and

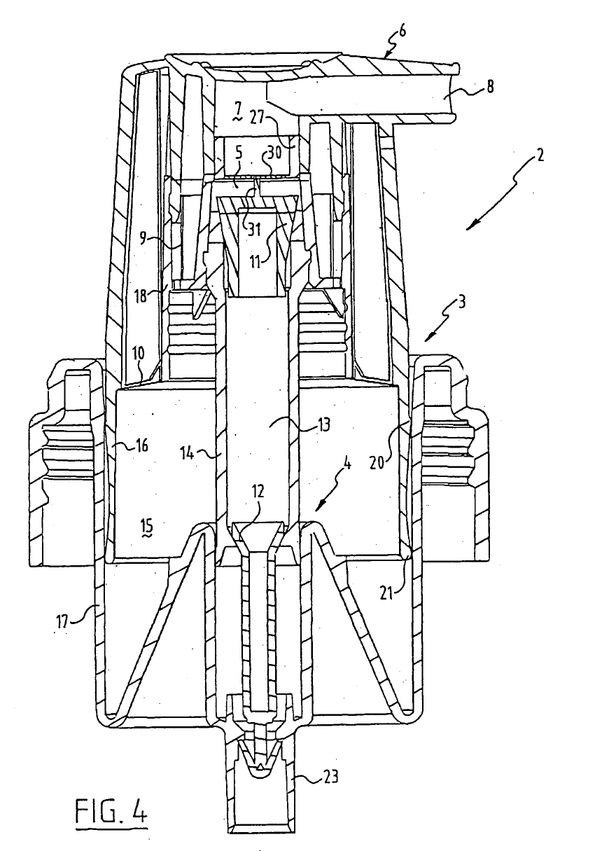

FIG. 4 shows a cross-section of another embodiment of a foam forming unit according to the invention.

The same reference numerals are used in each of the Figures for the same construction components.

In the perspective, cross-sectional view of FIG. 1 is shown a foam dispensing assembly consisting of a liquid container 1 and a foam forming unit 2. The foam forming unit 2 comprises a pump 3 for air and a pump 4 for liquid which are each provided with an inlet and an outlet. The inlet of air pump 3 is in communication with the environment, while the inlet of liquid pump 4 is in communication with the content of liquid container 1. Foam forming unit 2 further comprises a mixing chamber 5 which is in communication with the outlet of both air pump 3 and liquid pump 4.

On the top part of the assembly is situated a dispensing part 6 which is provided with an outflow channel 7 with a foam opening 8. Outflow channel 7 runs from mixing chamber 5 to foam opening 8. One or more foam forming elements are normally located in this channel 7.

Both the outlet and the inlet of each pump 3,4 are provided with a valve respectively 9,10,11,12 for delivering respectively drawing in air or liquid. Valve 12 in the inlet of liquid pump 4 is otherwise shown in FIGS. 2 and 3.

Liquid pump 4 comprises a pressure chamber 13 with a piston 14 which is displaceable relative to pressure chamber 13. It is otherwise noted that the term “piston” is understood to mean that part of the pump which is moved (compare FIG. 2 and FIG. 4). Pressure chamber 13 is further located between inlet valve 12, outlet valve 11 and piston 14 of liquid pump 4. In addition, air pump 3 comprises a pressure chamber 15 with a piston 16 which is displaceable relative to pressure chamber 15. Pressure chamber 15 of air pump 3 is bounded on one side by inlet valve 10 and outlet valve 9 and on the other side between pistons 14,16 of the two pumps 3,4, these pistons being placed concentrically relative to each other.

An operating member for operating the two pumps 3,4 is manufactured integrally with piston 16 of air pump 3. The operating member 16, or the piston 16 of air pump 3, is arranged slidably in a holder element 17 which holds the foam forming unit 2 in liquid container 1. Upon displacement of operating member 16, this movement is transmitted directly onto piston 16 to operate air pump 3. When operating member 16 is displaced the liquid pump 4 is also operated in that a coupling element 18 is arranged between operating member 16 and the piston 14 of liquid pump 4, which coupling element transmits the displacement of operating member 16 to piston 14 of liquid pump 4. Finally, it should also be noted that dispensing part 6 is in fact formed integrally with operating member 16, or the piston 16 of air pump 3.

FIG. 1 shows clearly that the valves 9,10,11 are formed by membranes of a predetermined thickness formed on construction elements 14. At a wall thickness of construction elements 14 and 18 of about 1 mm, the thickness of the cylindrical membranes is for instance 0.2 mm. Valves 9,10,11 are injected moulded from plastic simultaneously with air pump 3 or liquid pump 4 to form a single construction element 14, 18. For an understanding of the present invention it is noted that the coupling element 18 is deemed a part of air pump 3.

Coupling element 18 has on the side directed toward dispensing part 6 an extension 27 with two circular seats 28, 29 of different diameter. In these seats are placed one or more foam forming elements, for instance in the form of fine-mesh screens (not shown). In the embodiment of FIG. 4 the foam forming element is likewise located in the extension 27 of coupling element 18, but is in this case formed by a wall with holes 30 which are co-moulded during the injection moulding of coupling element 18. For a good foaming action the holes have a diameter of a maximum of about 0.2 mm, the wall in which they lie is about 0.2 mm thick and the wall contains between 100 and 200 holes, preferably about 150 holes. These specifications can be employed in reasonably uniform manner in foam forming units for cosmetic products.

In the second embodiment of the foam forming unit 2 shown in FIG. 4, outlet valve 11 of liquid pump 4 is formed by a separate conical stopper which co-acts with the upper edge of piston 14. On the stopper 11 is a rod 31 which lies in contact against the wall with holes 30. Through dimensioning and material choice this foam forming element 30 has acquired a determined flexibility, so that under the influence of pressure built up in pressure chamber 13, transferred through stopper 11 and rod 31, it can deform. Foam forming element 30 therefore serves in the first instance together with rod 31 to close valve 11. When the pressure in chamber 13 becomes greater than the resistance of foam forming element 30, the valve will be opened.

An aerating hole 19 is further arranged in holder element 17 to replenish liquid container 1 with air from the environment when liquid is pumped out of the container for foam dispensing. In a non-pressurized extreme position (see FIG. 2) of the foam dispensing assembly the aerating hole 19 is situated between two sealing ribs 20,21 of air piston 16. These sealing ribs 20,21 ensure that in the position shown in FIG. 2 no liquid can exit to the outside when the assembly is held upside down relative to this position. In the second extreme position shown in FIG. 3, air from outside can flow into liquid container 1 to replenish container 1 with air.

The positions shown in FIGS. 2 and 3 are two extreme positions of the assembly. Between these two positions is defined a stroke respectively in downward direction (from the position of FIG. 2 to the position of FIG. 3) and in upward direction (from the position of FIG. 3 to the position of FIG. 2). The upward stroke is the suction stroke, wherein air as well as liquid are drawn to the respective pressure chambers 13,15, while the downward stroke is the delivery stroke, wherein the air and the liquid are pressed out of pressure chambers 13,15 to mixing chamber 5.

The operation of the foam forming unit is described with reference to FIGS. 2 and 3, starting with FIG. 3. The operating member (air piston) 16, coupling element 18 and liquid piston 14 form a whole during operation of the foam dispensing assembly and are therefore designated below with the general term “piston”. Arranged between piston 14,16,18 and holder element 17 is a spring 22 which is not loaded in the position shown in FIG. 2.

In FIG. 3 the piston 14,16,18 is in its compressed position and is on the point of being pressed upward by the spring force of spring 22. During the upward stroke the volume of pressure chamber 15 of air pump 3 becomes larger, whereby the pressure becomes lower than the ambient pressure. Owing to this pressure difference the inlet valve 10 of air pump 3 is opened and a connection is established between the environment and air pressure chamber 15. The same applies for the volume in pressure chamber 13 of liquid pump 4. Here too the volume is increased, whereby the pressure falls and liquid is drawn out of liquid container 1 via a rise tube 23. Suction of liquid via inlet valve 12 is possible because the liquid piston 14 with sealing ribs 24,25 arranged thereon is displaced downward and a passage is created between inlet valve 12 and piston 14 to pressure chamber 13.

The pump is now in its uppermost position (FIG. 2), wherein both the air pressure chamber 15 and the liquid pressure chamber 13 are filled with respectively air and liquid. When a downward force is now exerted on piston 14,16,18 which is greater than the spring force of spring 22 plus the friction forces between piston 14,16,18 and holder element 17, piston 14,16,18 will displace downward. The volume in air pressure chamber 15 is reduced and the pressure therefore increased, whereby inlet valve 10, which was opened in the upward stroke, is now pressed shut, while outlet valve 9 is opened. The same applies for the volume in liquid pressure chamber 13, wherein the inlet valve 12 is pressed into its seat by the pressure increase so as to close the inlet of liquid pump 4. In addition, outlet valve 11 of liquid pump 4 is opened by the increased pressure in liquid pressure chamber 13.

The air and the liquid come together in mixing chamber 5. Because the airflow and the liquid flow collide with each other the two are mixed well. After the mixture has been carried through one or more foam forming elements foam is created which via outflow channel 7 leaves the foam opening a of the dispensing part 6 of the assembly. The resistance of the membrane 11 in the embodiment shown in FIGS. 1-3 and of the wall with holes as foam forming element 30 in the embodiment of FIG. 4 ensures that liquid does not flow freely out of liquid pump 4. The flow of liquid in mixing chamber 5 is hereby controlled and manageable. Tests have shown that this is essential to obtaining a good foam.

Because inlet valve 12 is provided with a stopper body which co-acts with the sealing ribs 24,25 arranged in piston 14, a liquid lock is further created. This means that in the rest position (FIG. 2) it is ensured that no liquid exits the assembly or comes to lie between piston 14,16,18 and holder element 17 when the pressure in container increases, for instance because the container is squeezed. When the pressure in liquid container 1 increases, stopper body 12 will be pressed against sealing rib 25 and thereby obstruct the passage for liquid to either of the pressure chambers 13,15.

Holder element 17 is provided with a number of peripheral segments, designated with reference numeral 26, for the purpose of limiting the stroke of piston 14,16,18 relative to pressure chambers 13,15. These peripheral segments lie in the first instance in the line of the cylindrical bottom wall of holder element 17, i.e. are injection moulded in this position together with holder element 17, and are bent during assembly of the foam dispensing assembly. During assembly the holder element 17 is snapped or screwed onto liquid container 1, whereafter piston 14,16,18 is placed on holder element 17 and the peripheral segments 26 are bent inward.

The present invention is of course not limited to the preferred embodiments shown in the drawings. Although the pumps 3,4 are shown as concentric, it is also possible to provide them eccentrically or adjacently of each other. An example of such a construction is to be found in the international patent application WO 99/54054. It is further also possible for instance to embody the inlet valve 12 for liquid pump 4 as a membrane formed on piston 14 or holder element 18, wherein a liquid lock will have to be provided in another manner. In any case there is provided according to the invention a simplified foam forming unit with a relatively small number of construction components.

1. Foam forming unit particularly suitable for a liquid container, comprising a pump for liquid and a pump for air, which are each provided with an inlet and an outlet, said foam forming unit further comprising a mixing chamber which is in communication with the outlet of each pump, a dispensing part provided with an outflow channel with a foam opening, the channel being in communication with the mixing chamber, and valves in respectively the inlet and the outlet of each pump for drawing in respectively delivering air and liquid, characterized in that one or more valves are formed integrally with the air pump or liquid pump into a single construction element.

2. Foam forming unit as claimed in claim 1, wherein each pump comprises a pressure chamber with a piston displaceable relative to the pressure chamber.

3. Foam forming unit as claimed in claim 2, wherein the outlet valve of the liquid pump is formed integrally with the piston of the liquid pump.

4. Foam forming unit as claimed in any of the claims 1-3, further comprising an operating member for operating the two pumps.

5. Foam forming unit as claimed in claim 4, wherein the operating member is formed integrally with the piston of the air pump.

6. Foam forming unit as claimed in claim 4 or 5, wherein a coupling element is arranged between the operating member and the piston of the liquid pump, wherein the coupling element transmits the displacement of the operating member to the piston.

7. Foam forming unit as claimed in claim 6, wherein the outlet valve and/or the inlet valve of the air pump is or are formed integrally with the coupling element.

8. Foam forming unit as claimed in any of the claims 1-7, wherein the single construction element is an injection moulded element of plastic.

9. Foam forming unit as claimed in claim 8, wherein a valve is formed by a membrane of a predetermined thickness formed on the injection moulded element.

10. Foam forming unit as claimed in any of the claims 1-9, wherein the inlet valve of the liquid pump is formed by a stopper body which co-acts with at least one sealing rib arranged in the piston of the relevant pump.

11. Foam dispensing assembly consisting of a liquid container and a foam forming unit, wherein the foam forming unit is formed by a foam forming unit as claimed in any of the claims 1-10.
